(19) United States
(12) Patent Application Publication
(10) Pub. No.: US 2010/0026812 A1
(43) Pub. Date: Feb. 4, 2010

(54) Optoeletronic Device for Helping and Controlling Industrial Processes

(76) Inventor: Edson Roberto Minatel, Sao Carlos (BR)

Correspondence Address: JOHN ALEXANDER GALBREATH, 2516 CHESTNUT WOODS CT, REISTERSTOWN, MD, 21136, US

(21) Appl. No.: 12/526,548

(22) PCT Filed: Feb. 14, 2008
(86) PCT No.: PCT/BR08/00044

§ 371 Date: Aug. 10, 2009

(30) Foreign Application Priority Data
Feb. 15, 2007 (BR) P10700691-8

(51) Int. Cl. H04N 7/18; G09G 5/00

(52) U.S. Cl. 348/159; 345/633; 348/E07.085

(57) ABSTRACT

The present invention refers to a device used for application in industrial processes that generates virtual environment, at the same visual field of the real objects in the line of production through optical illusion composed of visual indications (arrows, drawings, texts, indicators, icons, etc.) composed electronic, optical, hardware, software and mechanical parts, composed of dome (1) video or monitor generator (2); monitor adjust system (3); visualization window (4); transparent mirror with a single reflexive phase (5) supports (6) magnet (neodymium) (7); support tower (8); careen (9) having as function to encapsulate and protect all the equipment hardware; a support (10); adjusts in height (11) telescope tubes (12); a folded device (13) and a handle (14); being positioned over the workplace in a customized way for each application.

### FIELD OF INVENTION

The present invention refers to an optoelectronic device specially developed for application in industrial processes based on manual assembly with or without use of tools.

### DESCRIPTION OF THE INVENTION

The device, object of patent creates an interactive virtual environment, at the same visual field of the real objects in the line of production through optical illusion. This environment comprises visual indications (arrows, drawings, texts, indicators, icons, etc.) that conduct the assembler in the assemble task sequence of the product from that line and at the same time monitors whether its actions were performed according to what was informed.

The device is constituted of electronic parts, optical, hardware, software and mechanical and it is positioned on the desktop in a customized way for each application.

The research and development of the referred invent were motivated by the affirmation that most of industrial processes based on human manual assembly make use of workbenches or production lines where the components of the final product are disposed in containers or shelves labeled with reference code of the respective part (and/or its name). The assembler (employee in charge of the assembly) must locate them, take them and assemble them in a sequence way that in the end it is obtained the product from that workplace. Such assembly sequence is, in general, defined by engineering that studies the best way of producing a product. In this study, several factors related to productivity of the assembly line, the employee security and final product quality are considered.

The problem is in the fact that there are no guarantees that this sequence of assembly is respected and followed by the assembler. This subjectivity may also allow the assembly of a wrong format part or out of original project specifications. Another problem is related to the low productivity of this conventional method since the assembler wastes much time in the act of identifying, locating and thinking of the action to be taken up to the assembly.

As there is no control on the actions of the assembler, the conventional process may vary from person to person. This undesirable subjectivity of the conventional process brings high indexes of reworking (need of fixing parts) of the assembled parts, that is, bad quality on the final product, overtaxing the companies with reposition costs, after sales technical assistance and waste of the institutional image. It becomes more serious the fact that the learning curve for an employee to be skilled for the tasks from that workplace is too long and when the employee is well trained, he must be reallocated for other tasks in order to not suffer health problems, for example, RSI (Repetitive Strain Injury), or stress by sense hyper-stimulation (high levels of noise, visual pollution, etc.).

All such scope of problems generates a relative inefficiency in the production raising its costs and the industries with this assembly model become less competitive.

The invent now claimed also presents as novelty the fact of being a complete, integrated, low cost solution and that focuses as a preference to the help for the industrial assembler indicating the steps he must follow in a single way through optical illusions guarantying the industrial process execution defined by Engineering.

The virtual environments are created through optical illusions that generate visual marks overlapping the real objects of the desktop by combining light with intensities and directions pre-established, reflexes from the semi-transparent mirror, shadows and transparencies where the generated marks stay in the same visual field and have the same intensity the light of the real objects.

Simultaneously, optical sensors like video cameras monitor operator movements.

Equipment interactivity is performed by a software specially developed that interprets the assembler's movements by processing the signals or images from sensors/cameras and, based on a pre-established and customized logic for each assembly line, inform or alert assembler through mnemonic and iconographic visual marks.

The equipment used in the process in a summarized way use physical supports to position the sensors/video cameras and a set of illumination over the workplace where the assemblies will be performed.

As data input devices, it is used analogical or digital video cameras or any other type of electronic sensor coupled to a microcomputer. To generate the illusion of virtual objects video, TV monitors or any other images generators are used (multimedia projector, retro projected panels, LEDs bars, etc.), metallized mirror with transparency and illumination devices like lamps or LED's.

The invent was specially designed to be independent from the workbench/line in order to not suffer vibrations or impacts from them, being covered by a protective careen to isolate the internal components in the industrial environment, avoiding dirty and external light interfere on its operation.

The invention proposed brings together a positive aspect in relation to the economical and social point of view.

As to the economical point of view, the invent makes possible the reduction of the cost of human manual assembly in relation to automated assembly, improving quality and productivity taxes, avoiding in a preventive way the cost relative to health problems and minimizing the negative effects of the personnel rotativity in industries.

From the social point of view, the invention will help to maintain the jobs that would be substituted by automation of assembly tasks, will reduce the risk of health problems with RSI, stress, ophthalmologic and psychological problems.

The invention may be customized for each industrial assembly line or for different products inside the same industrial line, wherein its form or dimension may be readequated. For example, to generate visual mark, it is possible to use video monitor of several sizes. The position and dimensions of the mirror as well as its transparency and reflectance degrees may be adjusted. The important is that the invented concept/process is the same.

The video generator used by the invention may be a LCD or CRT monitor; TV LCD, CRT or Plasma; multimedia projector; LED's or lamps panel; luminous or retro-luminous billboard, or any other device capable of generate images of marks that will be reflected by the mirror.

Video cameras must be equipped with objectives suitable for the application. In general, they are objectives with angle lens that allow a larger area of framing the workplace.

As to the optical components the mirror must have transparency, that is, must allow that part of the light incident through its surface to be transmitted and must have only one reflexive face (metallized mirror). This attribute allows the image reflected to be clear and without the “ghost” effects from the mirror glass reflection (Example of commercial reference of the mirror model PN114, PN120 and PN150 of Cebrace/Pilkington). The set of illumination may be several types like LED's, fluorescent lamps, incandescent lamps, etc. and aims at illuminating the workplace so that the operator and the video camera visualizes it.

For the perfect operation of the invent, it was developed a software basically composed by three main modules that are:
Computer Visualization Module—software that will make the capture of the images of the workplace, identifying the position of the assembler hand and returning mathematic attributes that allow characterize the characteristic movement of the assembler.
User interface Module—part of software that shows (in an mirrored way). the marks and information on the video monitor in order to create “virtual objects” in the assembler workplace.
Process Manager Module—program that based on information of the Computer Visualization Module and a data bank for decision taken executes in sequence way the User Interface Module with the user.

The Hardware is basically composed of a microcomputer and peripheral that is responsible for processing the developed software.

If the video camera used to monitor the environment is not digital, the equipment makes use of an image capture board (frame grabber) for digitalizing analogical signals from the cameras.

Optionally, the system may have hardware to control the electronic devices and also control illumination.

As to the invent constitution, partly its mechanic to its constructive disposition and respective design, allows the workplace becomes free so that the operator may perform the assemblies and, at the same time, may visualize the virtual marks over the real objects from his workbench/line.

### STATE OF THE ART

Researches demonstrate that there are no identical or similar devices that use the operational technique now claimed.

This innovation comes, then, to provide several needs that were before solved in distinct, manual ways, usually operating in a non satisfactory way. Then, the innovation resultant from this invent allows the user final quality and precision in the usage of the technology now applied.

### ADVANTAGES OF THE INNOVATION

The innovation now proposed conceived through the present device consists of introducing such combination of hardware and software, replacing the conventional process, revealing several and important advantages for the users, among which:
Higher quality of the assembled product;
Higher productivity;
Self-explaining process;
Less learning time for use;
Avoids dismissal due to assemble tasks automation;
Lower index of rework or discharged parts;
Great flexibility being able to be used for several models of products;
Elimination or significant reduction of the subjectivity;
Better use of functional rotativity, eliminating or reducing the RSI (Repetitive Strain Injury);
Dispense of functional training;
Integration of the final user with its objective.
Avoid damages due to human error;
Better quality of life to the assembler, with elimination of RSI and stress due to industrial environment;

Thus, the invent now claimed comes to supply such deficiency, by using state-of-the-art technology producing a device applicable in industrial processes based on manual assembly with or without use of tools through optical illusions in a virtual interactive environment, at the same visual field of the real objects in the production line that conduct the monitor to the development of production work.

### DESCRIPTION OF THE DRAWINGS

For better understanding the functioning and operation of the present invention, and aiming at contributing for the understanding now proposed, the illustrative are showed wherein all the details may be observed.

FIG. 1, in perspective, in an illustrative drawing, indicates the general view of the equipment that is composed of dome (1) showed with no careen, video or monitor generator (2); monitor adjust system (3); visualization window (4); transparent mirror with a single reflexive phase (5) fixed by supports (6) for position and angles adjusts; magnet (neodymium) (7), which in contact with the dome walls dislocate the illumination chambers all over the metallic side, but may be substituted by screws or clinches, having no damages for the performance of the device; fixation of the mirror supports (6); and, support tower (8) may be produced in aluminum shaped or steel bars and supported on the floor of affixed on the ceilings or walls or any other structure that allows its support in the operation position.

FIG. 2, in perspective view, shows careen (9) covering the dome (1), having as a function to encapsulate and to protect all the equipment hardware, by isolating the internal components from industrial environment and avoiding the dirt and external light to interfere on its functioning; visualization window (4); transparent mirror with a single phase (5); magnets (7); and support tower (8).

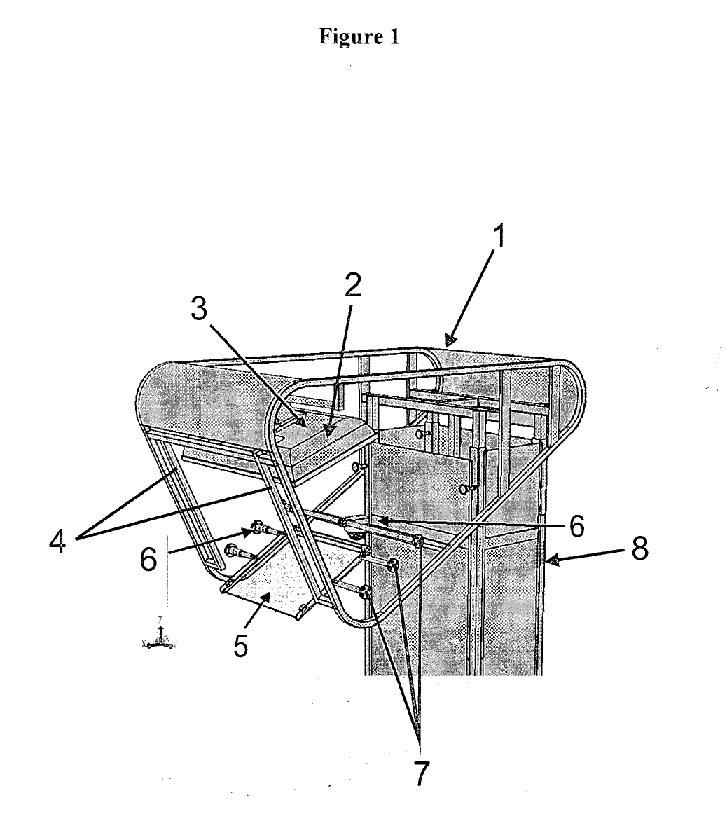

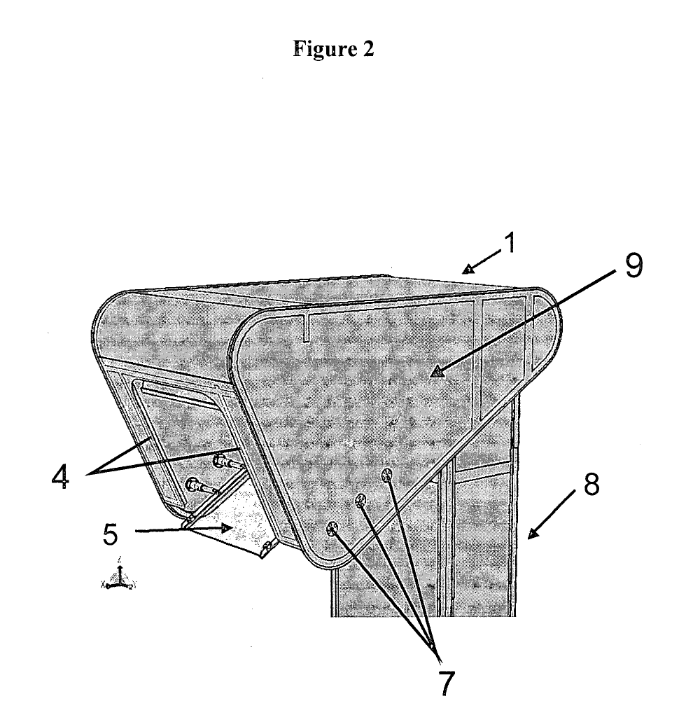

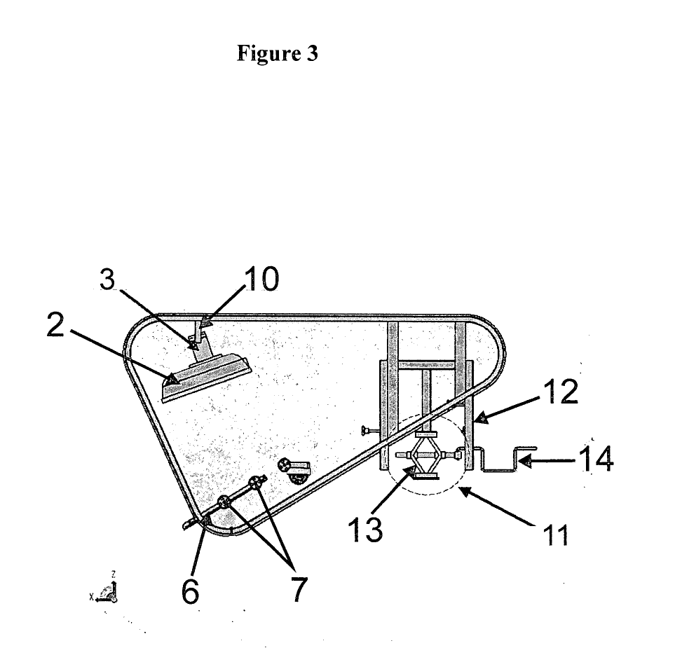

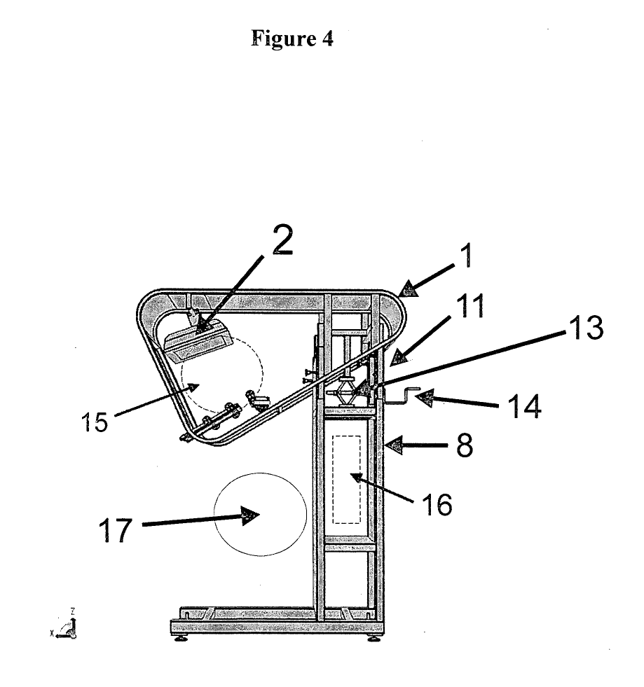

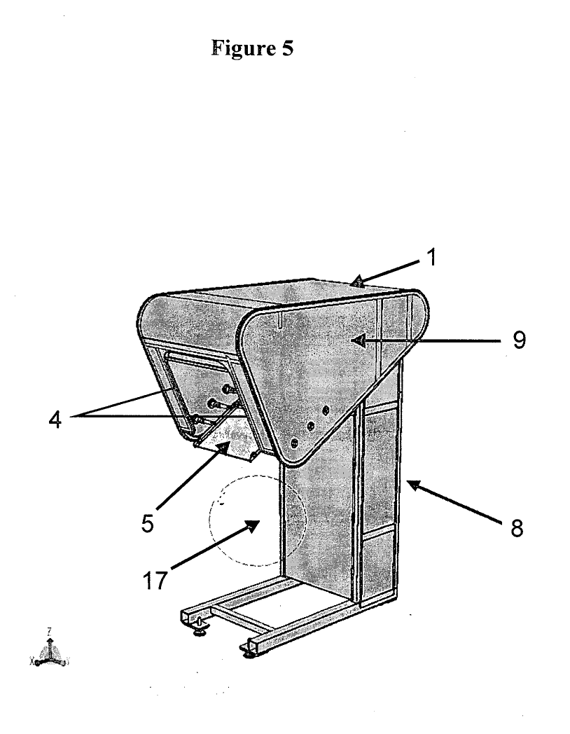

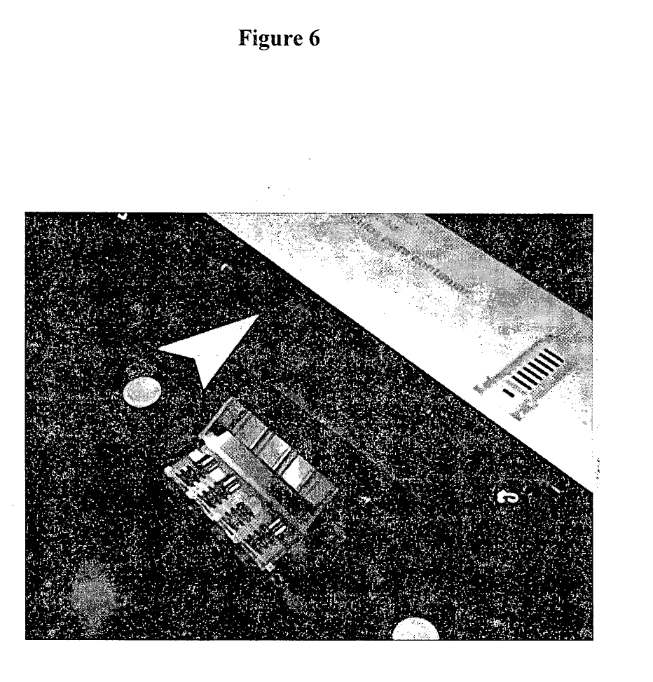

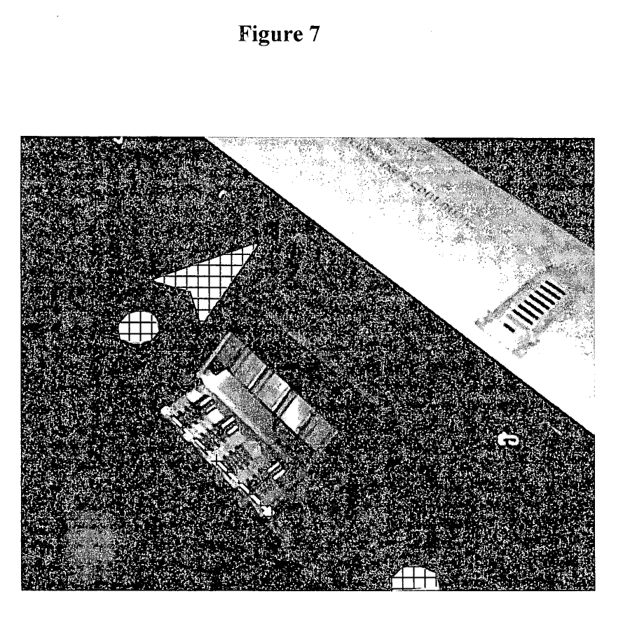

And FIG. 3, in a side view of the dome (1), with no covering or careen (9), emphasizes the main adjusts of the equipment internal components, such as: adjust system (3) monitor that may have its angle altered by a support (10) that holds it to a cylindrical axis; adjusts in height (11) that allows that all dome (1), fitted through telescope tubes (12) and a folded device (13) (jack) that pushes upwards, being possible to be lifted and lower, by using a handle (14); position adjusts and mirror angles (6) of the systems of displacement for all metallic sideway through magnet fixation (neodymium) (7).

FIG. 4 shows a dome side view (1) and tower (8) with no protective careen, making it possible to visualize internal equipment like. optical set (15), the height adjusts (11), folded device (13) and handle (14); hardware case (16) and space reserved for workplace (17) that may be workbench or assembly line.

FIG. 5, in perspective view, in an illustrative drawing, shows the dome device (1) and tower (8) with careen (9) which form was calculated in order to guarantee the ceiling reflex does not interfere in the visual field and at the same time encapsulates all internal components of the equipment, how the assembler must position in front of the equipment, that may work stand up or in a high chair, depending on Engineering of Process definition for the production line in the reserved space for the workplace (17) that may be workbench or assemble line, and look through the mirror with single phase and transparency (5) exposed on the Visualization Window (4).

FIG. 6 is showed an example of environment illusion seen by the assembler in his workplace.

FIG. 7 presents the same environment from FIG. 6, that is showed with all virtual objects checkered highlighted. The objects not highlighted are real objects. Arrows, circles and superior strips are virtual marks.

The exposition of the present invention is just illustrative and changes may be done in the details, especially as to the size, form, dimension, production, industrial and visual disposition always within the ideal principle to the extension indicated by the knowledge of the claim presented with the present patent application.

1. OPTOELETRONIC DEVICE, characterized by creat virtual environments through optical illusions that generate visual marks overlapping the real objects of the desktop by combining light with intensities and directions pre-established, reflexes from the semi-transparent mirror, shadows and transparencies where the generated marks stay in the same visual field and have the same intensity the light of the real objects, simultaneously, optical sensors like video cameras monitor operator movements, composed electronic, optical, hardware, software and mechanical parts, composed of dome (1) video or monitor generator (2); monitor adjust system (3); visualization window (4); transparent mirror with a single reflexive phase (5) supports (6) magnet (neodymium) (7); support tower (8); careen (9) having as function to encapsulate and protect all the equipment hardware; a support (10); adjusts in height (11) telescope tubes (12); a folded device (13) and a handle (14); being positioned over; the workplace in a customized way for each application.

2. OPTOELETRONIC DEVICE, according to claim 1, is characterized by Computer Visualization Module, User Interface Module and Process Manager Module.

3. OPTOELETRONIC DEVICE, according to claim 1, is characterized by use physical supports to position the sensors/video cameras and a set of illumination over the workplace where the assemblies will be performed.

4. OPTOELETRONIC DEVICE, according to claim 1, is characterized by use video generator that may be a LCD or CRT monitor; TV LCD, CRT or Plasma; multimedia projector; LED's or lamps panel; luminous or retro-luminous billboard, or any other device capable of generate images of marks that will be reflected by the mirror.
